(19) United States
(12) Patent Application Publication
(10) Pub. No.: US 2022/0190569 A1
(43) Pub. Date: Jun. 16, 2022

(54) CONNECTION STRUCTURE FOR HOUSING MEMBER AND PROTECTIVE TUBE

(71) Applicant: SUMITOMO WIRING SYSTEMS, LTD., Mie (JP)

(72) Inventors: Hiroki MORI, Mie (JP); Takahiro MURATA, Mie (JP)

(21) Appl. No.: 17/438,605

(22) PCT Filed: Mar. 19, 2019
(86) PCT No.: PCT/JP2019/011319

§ 371 Date: Sep. 13, 2021

(51) Int. Cl. H02G 3/06; B60R 16/02

(52) U.S. Cl. CPC H02G 3/0616; B60R 16/0215

(57) ABSTRACT

An object of the present invention is to keep a wire-shaped transmission member from being exposed to the outside. A connection structure for a housing member and a protective tube, the connection structure includes a wire-shaped transmission member, a housing member for housing a first portion which is a portion of the wire-shaped transmission member, a protective tube for covering a second portion which is another portion of the wire-shaped transmission member and an opposite-side housing member for housing a third portion that is on an opposite side to the first portion with the second portion interposed between the first portion and the third portion. The protective tube is formed to a length that reaches both the housing member and the opposite-side housing member.

### TECHNICAL FIELD

The present disclosure relates to a connection structure for a housing member and a protective tube.

### BACKGROUND

In Patent Document 1, a portion of a plurality of coated wires are housed in a grommet. The coated wires are covered with a corrugated tube. The corrugated tube and the grommet are connected to each other by an end portion of the corrugated tube being housed in the grommet.

### PRIOR ART DOCUMENT

### Patent Document

Patent Document 1: WO 2016/153045 A

### SUMMARY OF THE INVENTION

### Problems to be Solved

Here, it is desired that the coating wire is not exposed to the outside between the end portion of the corrugated tube and the grommet.

In view of this, an object of the present disclosure is to keep the wire-shaped transmission member from being exposed to the outside.

### Means to Solve the Problem

A connection structure for a housing member and a protective tube according to a first aspect of the present disclosure is a connection structure for a housing member and a protective tube, the connection structure including a wire-shaped transmission member, a housing member for housing a first portion, which is a portion of the wire-shaped transmission member, and a protective tube for covering a second portion, which is another portion of the wire-shaped transmission member, and an opposite-side housing member for housing a third portion that is on an opposite side to the first portion with the second portion interposed between the first portion and the third portion, wherein the protective tube is formed to a length that reaches both the housing member and the opposite-side housing member.

### Effect of the Invention

According to the present disclosure, a wire-shaped transmission member can be kept from being exposed to the outside.

### BRIEF DESCRIPTION OF THE DRAWINGS

FIG. 1 is a schematic plan view showing a connection structure for a housing member and a protective member according to an embodiment.

FIG. 2 is a partial exploded view of a connection structure for a housing member and protective tubes.

FIG. 3 is a partial cross-sectional view of FIG. 1.

FIG. 4 is a partial enlarged view showing a first variation.

FIG. 5 is a partial enlarged cross-sectional view showing a second variation.

FIG. 6 is a partial enlarged cross-sectional view showing a third variation.

FIG. 7 is a partial enlarged cross-sectional view showing a fourth variation.

FIG. 8 is a diagram showing an example in which wire harnesses including connection structures for a housing member and a protective tube is incorporated in a vehicle.

### DETAILED DESCRIPTION TO EXECUTE THE INVENTION

### Description of Embodiment of Disclosure

First, embodiments of the present disclosure will be listed and described.

A connection structure for a housing member and protective member according to the present disclosure is as follows.

(1) A connection structure for a housing member and a protective tube includes a wire-shaped transmission member, a housing member for housing a first portion, which is a portion of the wire-shaped transmission member, and a protective tube for covering a second portion, which is another portion of the wire-shaped transmission member, and an opposite-side housing member for housing a third portion that is on an opposite side to the first portion with the second portion interposed between the first portion and the third portion, wherein the protective tube is formed to a length that reaches both the housing member and the opposite-side housing member.

Since the protective tube is formed to a length that reaches both the housing member and the opposite-side housing member, the wire-shaped transmission member can be kept from being exposed to the outside. Also, the connection state of the protective tube and the housing member and the opposite-side housing member can be readily maintained.

(2) A configuration is also possible in which the housing member includes a housing body portion for housing the first portion and an extended portion that protrudes from the housing body portion toward the second portion, and an end portion of the protective tube overlaps the extended portion in a direction in which the wire-shaped transmission member extends. Since the end portion of the protective tube overlaps the extended portion in the direction in which the wire-shaped transmission member extends, the wire-shaped transmission member is further unlikely to be exposed to the outside.

(3) A configuration is also possible in which the end portion of the protective tube covers the extended portion. Since the diameter of the connecting portion of the protective tube and the extended portion is approximately that of the protective tube, the connection structure for the housing member and the protective tube can be made smaller.

(4) A configuration is also possible in which a boundary between the housing body portion and the extended portion is the mark. Since the protective tube covers the extended portion, the end portion of the protective tube can be visually observed. Whether the protective tube appropriately covers the extended portion can be confirmed based on the positional relationship between the end portion of the protective tube and the mark.

(5) A configuration is also possible in which a boundary between the housing body portion and the extended portion is the mark. By confirming whether the protective tube reaches the boundary between the housing main portion and the extended portion or the relationship between the end portion of the protective tube and the boundary, it is possible to confirm whether the protective tube appropriately cover the extended portion.

(6) A configuration is also possible in which the end portion of the protective tube is inserted into the extended portion. Accordingly, the end portion of the protective tube can be protected in the extended portion.

### Description of Embodiments of Disclosure

Hereinafter, specific examples of a connection structure for a housing member and a protective member will be described. Note that, the present invention is not limited to these examples, but defined in the claims, and intended to include all modifications within the meaning and the scope equivalent thereof.

### Embodiment

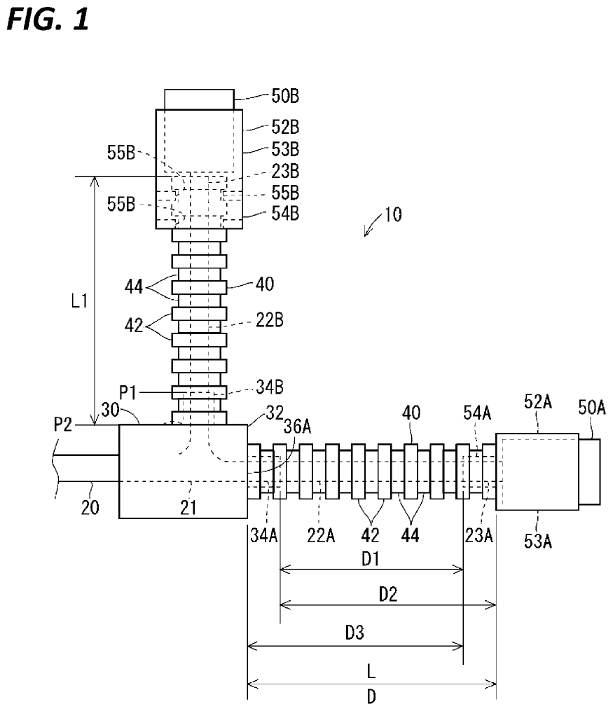

Hereinafter, a connection structure for a housing member and a protective member according to a first embodiment will be described. FIG. 1 is a schematic plan view showing a connection structure 10 for a housing member and a protective member. This connection structure 10 for a housing member and a protective member includes a wire-shaped transmission member 20, a housing member 30, protective tubes 40, and connector covers 52A and 52B. The connector covers 52A and 52B are an example of an opposite housing member.

The wire-shaped transmission member 20 may be a wire-shaped member that transmits electricity, light, or the like. For example, the wire-shaped transmission member may be an ordinary wire having a core wire and a coating around the core wire, a bare conductive wire, a shielded wire, a twisted wire, an enamel wire, a nichrome wire, an optical fiber, or the like. As a wire-shaped transmission member for transmitting electricity, the wire-shaped transmission member may also be various kinds of signal lines or power lines. Also, the wire-shaped transmission member may be a single wire-shaped member or a composite member (e.g., a twisted wire or a cable formed by collecting a plurality of wire-shaped objects and covering these with a sheath).

Hereinafter, an example in which the wire-shaped transmission member 20 is constituted by wires 20 will be described. The wires 20 are wiring members for electrically connecting electrical components to each other in a vehicle. Here, a plurality of wires 20 are bundled in a form corresponding to wiring routes in the vehicle. For this reason, the connection structure 10 may also be taken as a portion included in a wire harness including the plurality of wires. Here, the wires 20 are bundled while being branched. Note that in the drawings, the wires 20 are shown in bundled form. In this embodiment, the wires 20 are bundled extending in three directions, more specifically, branching in a T-shape. In this embodiment, the branching portion of the wires 20 is a first portion 21, and the two portions extending from the first portion 21 are second portions 22A and 22B. Also, in the wires 20, third portions 23A and 23B are present on the opposite sides to the first portion 21 with the second portion 22A interposed between the first portion 21 and the third portions 23A and 23B. Here, the third portions 23A and 23B are end portions of the wires 20.

The housing member 30 is a member for housing the first portion 21 which is a portion of the wires 20. Here, the housing member 30 houses the branching part as the first portion 21 of the wires 20. In other words, the housing member 30 maintains the branching part of the wires 20 in a fixed branching shape. The housing member 30 may also be a water blocking component for keeping water from flowing along the wires 20.

The housing member 30 may also be a resin component formed by die-forming with the first portion 21 of the wires 20 serving as an inserted portion. The housing member 30 may also be a component formed by combining a pair of case-shaped resin components that can house the first portion 21 of the wires 20.

The protective tubes 40 are tubular members that cover the second portions 22A and 22B that are the other portions of the wires 20. Here, a description will be given on the assumption that the protective tubes 40 are corrugated tubes in which large diameter portions 42 and small diameter portions 44 are alternately arranged. Recesses 42g that open toward the inner circumference are formed on the inner side of the large diameter portions 42 of the inner circumferential portion of each protective tube 40. Since the recesses 42g are formed over the entirety in the circumferential direction of the large diameter portions 42, the recesses 42g are annular recesses 42g formed along the circumferential direction of the protective tubes 40. The annular recesses 42g include the end portion of the protective tube 40, and a plurality of annular recesses 42g are formed at intervals over the entirety in the longitudinal direction of the protective tube 40. The protective tubes 40 may also be formed in a tubular shape in which portions having the same shape are continuous.

Connectors 50A and 50B are connected at the end portions of the wires 20. The connector covers 52A and 52B respectively cover the base end portions of these connectors 50A and 50B. In other words, terminals are connected to the end portions of the wires 20, and the terminals are held in the cavities formed in the connectors 50A and 50B. The wires 20 extend outward from the end portions of the connectors 50A and 50B. Since the connector cover 52A covers the third portion 23A of the wires 20 that includes a portion in the connector 50A and a portion extending from the base end side of the connector 50A, the connector cover 52A is an example of the opposite-side housing member. Similarly, since the connector cover 50B covers the third portion 23B of the wires 20 that includes a portion in the connector 50B and a portion extending from the base end side of the connector 50B, the connector cover 52B is an example of the opposite-side housing member.

The housing member 30 houses the first portion 21 of the wires 20, the protective tubes 40 cover the second portions 22A and 22B of the wires 20, and the connector covers 52A and 52B house the third portions 23A and 23B of the wires 20. In this case, in order to protect the wires 20, the housing member 30 and the protective tubes 40 may cover the wires 20 such that the wires 20 are not exposed between the housing member 30 and the protective tube 40. Also, the connector covers 52A and 52B and the protective tubes 40 may cover the wires 20 without the wires 20 being exposed between them. In view of this, the connection structure 10 for the housing member and the protective tube adopts the following configuration.

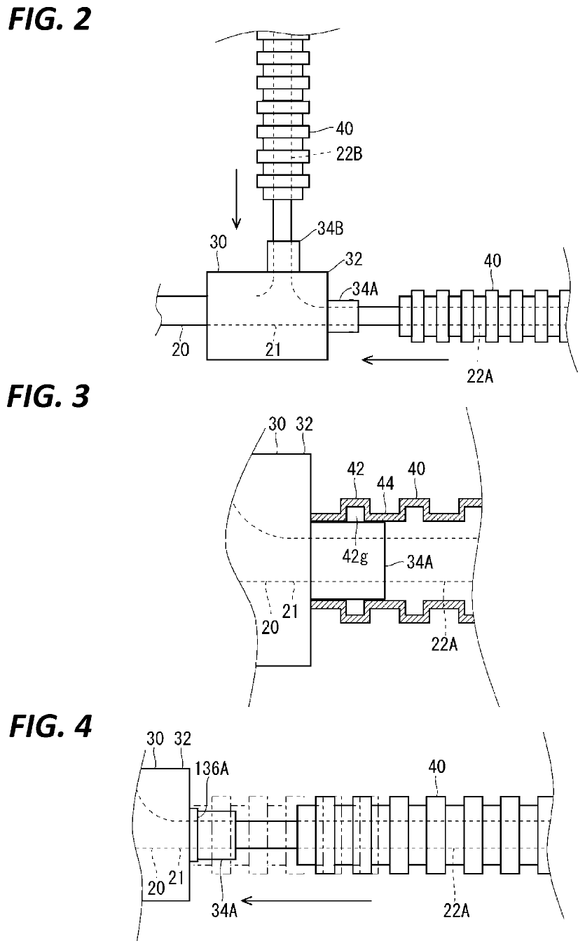

FIG. 2 is a partial exploded view of a connection structure 10 for a housing member and protective tubes, and FIG. 3 is a partial cross-sectional view of FIG. 1.

As shown in FIGS. 1 to 3, the protective tubes 40 are formed to a length that reaches the housing member 30 and the connector covers 52A and 52B. Here, a state in which “the protective tubes 40 reach the housing member 30” refers to a state in which “the end portion of the protective tubes 40 comes in contact with the housing member 30, or the protective tubes 40 overlap at least a portion of the housing member 30 in the direction in which the wires 20 extend”. In this manner, the wires 20 can be kept from being exposed between the protective tubes 40 and the wiring member 30. Similarly, a state in which “the protective tubes 40 reach the connector covers 52A and 52B” refers to a state in which “the end portion of the protective tubes 40 overlaps the connector covers 52A and 52B, or the protective tubes 40 come in contact with at least a portion of the connector covers 52A and 52B in the direction in which the wires 20 extend”. In this manner, the wires 20 can be kept from being exposed between the protective tubes 40 and the connector covers 52A and 52B.

In this embodiment, the housing member 30 is provided with a housing body portion 32 and extended portions 34A and 34B.

The housing body portion 32 houses the first portion 21 of the wires 20. Here, the housing body portion 32 houses the first portion 21, which is the branching portion of the wires 20. Due to the housing body portion 32, the branching shape of the wires 20 is maintained in a fixed shape and protected. More specifically, the housing body portion 32 is formed in a cuboid shape. The housing body portion 32 does not need to be formed in a cuboid shape, and may also be formed in any other shape. For example, the housing body portion may also have a shape in which recesses or protrusions are formed in a cuboid-shaped portion, or a shape in which planes and curved surfaces are combined. The wires 20 are guided into the housing body portion 32 from one side face side of the housing body portion 32. The first portion 21, which is the branching portion of the wires 20, is housed in the housing body portion 32, and the second portions 22A and 22B, which are branched and extend from the first portion 21, respectively extend outward from another side face and a side face that is adjacent thereto of the housing body portion 32.

The extended portions 34A and 34B protrude from the housing body portion 32 toward the second portions 22A and 22B of the wires 20. Here, the extended portion 34A is formed in a cylindrical shape that protrudes from a side face of the housing body portion 32. The portion of the first portion 21 of the wires 20 that extends from the side face of the housing body portion 32 is housed in the extended portion 34A. The second portion 22A extends outward from the leading end portion of the extended potion 34A. The extended portion 34B is formed in a cylindrical shape that protrudes from another side face of the housing body portion 32. The portion of the first portion 21 of the wires 20 that extends from the other side face of the housing body portion 32 is housed in the extended portion 34B. The second portion 22B extends outward from the leading end portion of the extended portion 34B. The extended portions 34A and 34B may also be formed in a rectangular cylindrical shape.

When it is assumed, for example, that the housing member 30 is a resin member formed by die-forming with the first portion 21 serving as an inserted portion, the extended portions 34A and 34B are assumed to be resin portions formed by die-forming with the first portion 21 serving as the inserted portion, with the housing body portion 32. It is assumed that, for example, the housing member 30 is a component that is formed by a pair of case-shaped resin parts being combined and can house the first portion 21. In this case, the extended portions 34A and 34B are assumed to be semi-cylindrical portions divided along with the housing body portion 32, and portions combined so as to sandwich the first portion 21 therebetween.

The extended portions 34A and 34B have diameters that can be inserted into the end portion of each protective tube 40. Here, the outer diameters of the main body portions of the extended portions 34A and 34B are set smaller than the inner diameter of the protective tubes 40.

The connector cover 52A is a member provided with a housing body portion 53A and an extended portion 54A, and is, for example, formed by die-forming a resin or the like. The connector cover 220 may be a component formed in one-piece by molding, or a component formed by combining a pair of case-shaped resin parts. The connector cover 52A may also be formed by an elastic material such as rubber.

The housing body portion 53A covers the rear end portion of the connector 50A and houses the third portion 23A, which is the end portion of the wires 20 with the connector 50A. The extended portion 54A is a tubular portion that extends from the base end portion of the housing body portion 53A, and houses the third portion 23A of the wires 20 that extends from the base end portion of the housing body portion 53A. The portion of the wires 20 that is located between the extended portion 34A and the extended portion 54A is the second portion 22A.

The connector cover 52B is a member provided with the housing body portion 53B and the holding portion 54B, and is a component formed by die-forming a resin or the like. The connector cover 220 may be a component formed in one-piece by molding, or a component formed by combining a pair of case-shaped resin parts. The connector cover 52B may also be formed by an elastic material such as rubber.

The housing body portion 53B covers the rear end portion of the connector 50B and houses the third portion 23B, which is the end portion of the wires 20 with the connector 50B. The extended portion 54B is a tubular portion that extends from the base end portion of the housing body portion 53B. The holding portion 54B is formed in a shape that can house the other end portion of the protective tube 40, and a tube positioning protrusion 55B that fits into the annular recess in the other end portion of the protective tube 40 is formed at the inner circumferential portion. The holding portion 54B houses the third portion 23B of the wires 20 that extends from the base end side of the housing body 53B with the other end portion of the protective tube 40. The connector cover 52B may also have a configuration in which two divided parts are joined together in a state in which the pinch and fix the connector 50B and the other end portion of the protective tube 40 therebetween. The portion of the wires 20 that is located between the extended portion 34B and the holding portion 54B is the second portion 22B.

Between the housing member 30 and the connector cover 52A, the protective tube 40 is formed to a length that reaches both the housing member 30 and the connector cover 52A. Here, one end portion of the protective tube 40 is in contact with the housing body portion 32 in a state in which it covers the extended portion 34A. The one end portion of the protective tube 40 overlaps the extended portion 34A that is a constituent element of the housing member 30 in the direction in which the wires 20 extend, and thus the protective tube 40 reaches the housing member 30. Also, the other end portion of the protective tube 40 is in contact with the housing body portion 53A in a state in which it covers the extended portion 54A. The other end portion of the protective tube 40 overlaps the extended portion 54A that is a constituent element of the connector cover 52A in the direction in which the wires 20 extend, and thus the protective tube 40 reaches the connector cover 52A.

A length L of the protective tube 40 is considered in terms of the relationship between the protective tube 40 and the various members. The length L of the protective 40 preferably exceeds a distance D1 between the extended portion 34A and the extended portion 54A. Also, the length L of the protective tube 40 is preferably larger than the larger of a distance D2 between the extended portion 34A and the housing body portion 53A and a distance D3 between the housing body portion 32 and the extended portion 54A, in the direction in which the wires 20 extend. In this manner, a state in which the protective tube 40 covers the extended portions 34A and 54A is easily maintained. The length L of the protective tube 40 may be set to the same as the distance D3 between the housing body portion 32 and the housing body portion 53A, for example. Also, the length L of the protective tube 40 is preferably larger than the distance D between the housing body portion 32 and the housing body portion 53A in the direction in which the wires 20 extend. In this case, the protective tube 40 is arranged in a compressed state between the housing body portion 32 and the housing body portion 53A.

Between the housing member 30 and the connector cover 52B, the protective tube 40 is formed to a length that reaches both the housing member 30 and the connector cover 52B. Here, one end portion of the protective tube 40 is in contact with the housing body portion 32 in a state in which it covers the extended portion 34B. The one end portion of the protective tube 40 overlaps the extended portion 34B that is a constituent element of the housing member 30 in the direction in which the wires 20 extend, and thus the protective tube 40 reaches the housing member 30. Also, the other end portion of the protective tube 40 is held in the holding member 54B. The other end portion of the protective tube 40 overlaps the extended portion 54B, which is a constituent element of the connector cover 52B in the direction in which the wires 20 extend, and thus the protective tube 40 reaches the connector cover 52B.

In other words, the other end portion of the protective tube 40 is held in a state in which it is positioned by the holding portion 54B. Based on the position where the other end portion of the protective tube 40 is positioned by the holding portion 54B, a length L1 of the protective tube 40 is set to a length that can exceed a position P1 at the leading end of the extended portion 34B and reach a position P2 of the housing member 30. The protective tube 40 may be set to such a length that the one end portion thereof comes in contact with the housing member 30, or such a length that the one end portion covers the extended portion 34B. Similarly to the above, the length L1 of the protective tube 40 may also be a length that can be compressed between the housing member 30 and the connector cover 52B.

According to this connection structure 10 for the housing member and the protective tubes, the protective tubes 40 are formed to a length that can reach both the housing member 30 and the connector covers 52A and 52B that are the opposite-side housing members. For this reason, the wires 20 can be kept from being exposed to the outside between the housing member 30 and the protective tubes 40, or between the connector covers 52A and 52B and the protective tubes 40.

Also, the connection state of the protective tubes 40 and the housing member 30 or the connector covers 52A and 52B can be maintained due to the setting of the distance between the housing member 30 and the connector covers 52A and 52B, and the length of the protective tubes 40. In this manner, there is no need for a special configuration for connecting the protective tubes 40 and the housing member 30 or the connector covers 52A and 52B, such as a hooking structure, a belt-fastening structure, a tape-winding-and-fixing structure, and the like, and the connection state of these members is maintained with a simple configuration.

Also, since the end portions of the protective tubes 40 overlap the extended portions 34A, 34B, 54A, and 54B, a gap is unlikely to be generated between the protective tubes 40 and the housing member 30, the connector covers 52A, and 52B, and the wires 20 are further unlikely to be exposed to the outside.

Furthermore, since the end portions of the protective tubes 40 cover the extended portions 34A, 34B, and 54A, the diameters of the connecting portion of the protective tubes 40 and the extended portions 34A, 34B, and 54A are similar to that of the protective tubes 40. For this reason, the connection structure 10 can be made smaller. Also, the protective tubes 40 cover the extended portions 34A, 34B, and 54A, and the end portion of the protective tubes 40 can be externally observed. For this reason, whether and the extent to which the protective tubes 40 covers the extended portions 34A, 34B, and 54A can be easily confirmed.

### Variations

Variations will be described on the premise of the above-described embodiment.

FIG. 4 is a partial enlarged view showing a first variation. In this variation, a mark 136A that indicates an appropriate position of the protective tube 40 that covers the extended portion 34A is formed at the extended portion 34A. Here, a protrusion protruding in an annular shape from the main body of the extended portion 34A is formed at the base end portion of the extended portion 34A. The level difference on the leading end side of this protrusion is the mark 136A.

When covering the extended portion 34A with the protective tube 40, the relative positional relationship between the end portion of the protective tube 40 and the mark 136A gives a visual confirmation that the end portion of the protective tube 40 exceeds the mark 136A. In this manner, it is possible to confirm whether the protective tube 40 securely covers the extended portion 34A. Specifically, since the protective tube 40 covers the extended portion 34A, the end portion of the protective tube 40 can be visually confirmed. Also, whether the protective tube 40 appropriately covers the extended portion 34A can be confirmed based on the positional relationship between the end portion of the protective tube 40 and the mark 136A.

In this variation, a protrusion is formed at the extended portion 34A, and a level difference of the protrusion forms the mark 136A. In the above-described first embodiment as well, it may also be confirmed whether the protective tube 40 appropriately covers the extended portion 34A, by setting the boundary between the housing body portion 32 and the extended portion 34A as a mark 36A and confirming the positional relationship between the end portion of the protective tube 40 and the mark 36A. It may also be determined that the protective tube 40 appropriately covers the extended portion 34A, if the end portion of the protective tube 40 reaches the mark 36A, for example, in other words, if the end portion is in contact with the housing body portion 32. Also, if the distance between the end portion of the protective tube 40 and the mark 36A is a predetermined length or less, it may also be determined that the protective tube 40 appropriately covers the extended portion 34A.

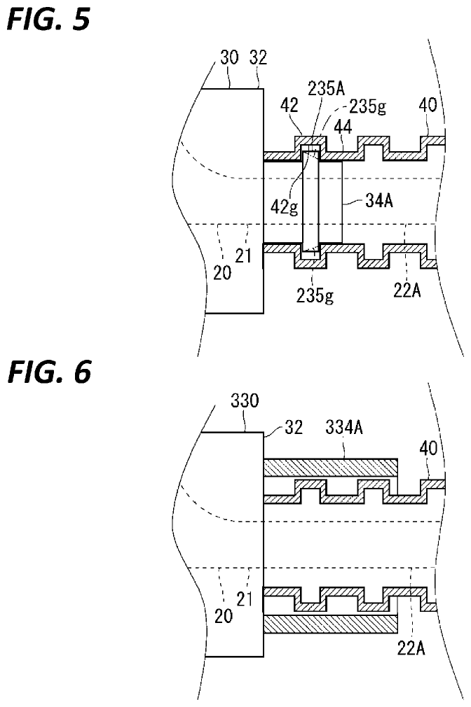

FIG. 5 is a partial enlarged cross-sectional view showing a second variation. In this variation, the positioning protrusion 235A that fits into the annular recess 42g of the protective tube 40 is formed in the extended portion 34A. Here, the positioning protrusion 235A is formed in an annularly protruding shape that protrudes along the circumferential direction of the extended portions 34A and 34B, and formed between the leading end portion and the base end portion of the extended portion 34A. The outer diameter of the positioning protrusion 235A is larger than the minimal inner diameter of the protective tubes 40 and smaller than or equal to the inner diameter of the annular recesses 42g. Also, the thickness of the positioning protrusion 235A is smaller than or equal to the width (width in the direction along the axial direction of the protective tubes 40) of the annular recesses 42g. As a variation of the positioning protrusion 235A, inclined surfaces 235g (see the two-dot-chain lines in FIG. 5) may also be provided. The inclined surfaces 235g are portions that make it easy for the protective tubes 40 to be externally fitted. It suffices that, for example, the inclined surface 235g is formed on the outer surface of the positioning protrusion 235A so as to inwardly incline toward the leading end of the extended portion 34A. In this manner, when the protective tube 40 is externally fitted to the extended portion 34A, the protective tube 40 abuts against the inclined surface 235g and is smoothly guided toward the base end side of the extended portion 34A. This makes it easier for the protective tube 40 to be externally fitted to the extended portion 34A. Also, in the state in which the protective tube 40 covers the extended portion 34A, the base end side portion of the extended portion 34A of the positioning protrusion 235A is fitted into the annular recess 42g, and thus the protective tube 40 is unlikely to come out of the extended portion 34A.

The extended portion 34A is covered with the end portion of the protective tube 40 such that the extended portion 34A is pressed into the end portion of the protective tube 40, and the positioning protrusion 235A is fitted into the annular recess 42g of the end portion of the protective tube 40. In this manner, the protective tube 40 is unlikely to come out of the extended portion 34A.

FIG. 6 is a partial enlarged cross-sectional view showing a third variation. In this variation, an extended portion 334A is provided instead of the extended portion 34A. The inner diameter of the extended portion 334A is set larger than the outer diameter of the protective tube 40. For this reason, the end portion of the protective tube 40 can be inserted into the extended portion 334A.

In this example, one end portion of the protective tube 40 reaches the housing member 330 including the extended portion 334A in a state in which it is inserted into the extended portion 334. As described above, since the protective tube 40 is formed to a length that reaches the housing member 330 and the connector cover 52A, the end portion of the protective tube 40 is unlikely to come out of the extended portion 334A, and the wires 20 are unlikely to be exposed to the outside between the protective tube 40 and the housing member 330.

According to this variation, since the end portion of the protective tube 40 is inserted into the extended portion 334A, the end portion of the protective tube 40 can be protected in the extended portion 334A. Also, as described above, due to the setting of the length of the protective tube 40, a configuration in which the protective tube 40 is unlikely to come out of the extended portion 334A is ensured, there is no need for a structure for hooking the end portion of the protective tube 40 to be provided at the extended portion 334A or the like. Furthermore, confirmation as to whether the end portion of the protective tube 40 sufficiently fit into the extended portion 334A may be omitted.

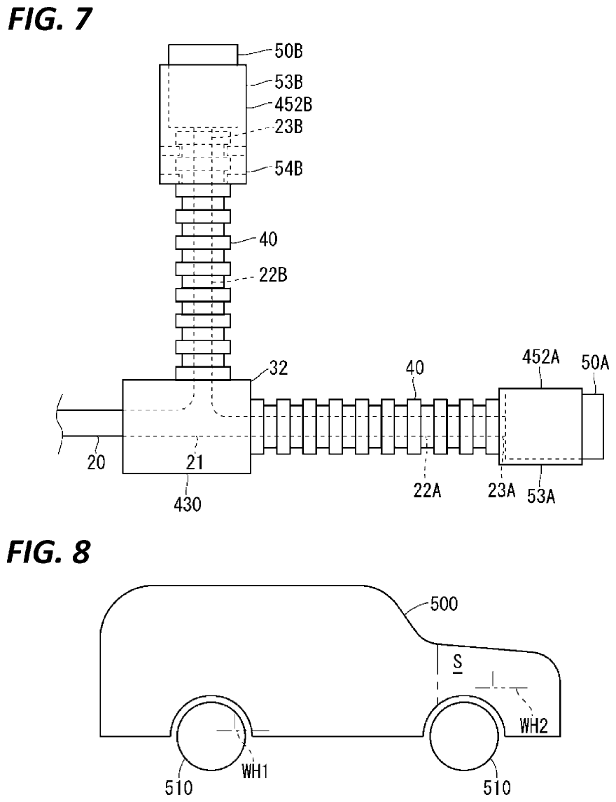

FIG. 7 is a partial enlarged cross-sectional view showing a fourth variation. In this variation, the extended portions 34A and 34B are omitted from a housing member 430 that corresponds to the housing member 30 according to the aforementioned embodiment. Also, the extended portion 54A is omitted from a connector cover 452A that corresponds to the connector cover 52A.

In this case as well, if the protective tubes 40 are set to a length that reaches and comes in contact with the housing member 430 and the connector cover 452A, the wires 20 are unlikely to be exposed between the protective tube 40 and the housing member 430 and the connector cover 452A. Similarly, if the protective tube 40 is set to a length that reaches and comes in contact with the housing member 430 from the connector cover 452B, the wires 20 are unlikely to be exposed between the protective tube 40 and the housing member 430.

In the above-described first embodiment, the housing member 30 need not necessarily house the branching portion of the plurality of wires 20. The housing member may house intermediate portions, in the direction in which the wires extend, of the wires, or the end portions of the wires. The same applies to the above-described variations.

The connector cover described in the embodiments and variations may also be a portion molded in one piece with the connector.

FIG. 8 is a diagram showing an example in which wire harnesses WH1 and WH2 including the above-described connection structures 10 for the housing member and the protective tube and the like are incorporated in a vehicle.

The wire harness WH1 can be attached to a vehicle as a wiring member for connecting a vehicle body 500 and wheels 510, for example. The wire harnesses for the wheels need to be arranged in narrow spaces between wheel housings and the wheels 510. Furthermore, since the wire harnesses are arranged in the surroundings of the wheels, relatively high protection is required. The connection structures 10 and the like have a configuration that can achieve reduction in size of the connection structure 10 and the like while suppressing exposure of the wires 20 between the protective tubes 40 and the housing members 30 and the like. For this reason, the connection structure 10 is suitable for use as the wire harness WH1 for connecting the vehicle body 500 and the wheels 510 to each other.

Furthermore, the wire harness WH2 is located forward of the vehicle cabin of the vehicle, for example, and can be attached as a wiring member arranged in a space S that is separated from the outside. In vehicles provided with an internal combustion, the space S is a space referred to as an engine room, and in electric cars, the space S is a space in which an electric motor may be arranged. The space S may also be taken as a space S in which a power generator such as an internal combustion and an electric motor is arranged. Since the space S is an environment that is likely to vibrate due to the internal combustion or the electric motor, vibration is also applied to the wiring member arranged in the space S.

The protective tubes 40 are set to a length that reaches the housing member 30 and the connector covers 52A and 52B. For this reason, if the wire harness WH2 including the connection structure 10 is arranged in the aforementioned space S, even in an environment with vibrations, a state in which the protective tubes 40 reach the housing member 30 and the connector covers 52A and 52B is easily maintained. Especially, the end portion of the protective tubes 40 overlap the extended portions 34A, 34B, and 54A, and holding portion 54B. For this reason, even when the wire harness WH2 vibrates, in the portions at which the protective tubes 40 cover the extended portions 34A, 34B, and 54A, even if the protective tubes 40 are displaced, exposure of the wires 20 can be suppressed. Accordingly, even in an environment with vibrations, the wires 20 can be sufficiently protected with a simple configuration.

Note that the configuration described in the embodiments and variations can be appropriately combined with each other as long as no contradictions arise. For example, in one end portions and the other end portions of the protective tubes, a configuration in which the protective tubes overlap the extended portion and a configuration in which the extended portion is omitted as in the fourth variation may also be adopted at the same time.

Although the present invention was described in detail as above, the above description is exemplary in all aspects, and should not be construed as limiting thereto. It should be construed that uncounted variations that have not been exemplified are conceivable without departing from the scope of the present invention.

### LIST OF REFERENCE NUMERALS

10 Connection structure for housing member and protective tube

20 Wire-shaped transmission member (wire)

21 First portion

22A, 22B Second portion

23A, 23B Third portion

30 Housing member

32 Housing body portion

34A, 34B Extended portion

36A Mark

40 Protective tube

42 Large diameter portion

42g Annular recess

44 Small diameter portion

50A, 50B Connector

52A, 52B Connector cover

53A, 53B Housing body portion

54A Extended portion

54B Holding portion

55B Tube positioning protrusion

136A Mark

235A Positioning protrusion

330 Housing member

334A Extended portion

430 Housing member

452A, 452B Connector cover

500 Vehicle body

510 Wheel

S Space

WH1, WH2 Wire harness 1

1. A connection structure for a housing member and a protective tube, the connection structure comprising:
a wire-shaped transmission member;
a housing member for housing a first portion, which is a portion of the wire-shaped transmission member; and
a protective tube for covering a second portion, which is another portion of the wire-shaped transmission member, and
an opposite-side housing member for housing a third portion that is on an opposite side to the first portion with the second portion interposed between the first portion and the third portion,
wherein the protective tube is formed to a length that reaches both the housing member and the opposite-side housing member, and
the protective tube is in a compressed state between the housing member and the opposite-side housing member.

2. A connection structure for a housing member and a protective tube, the connection structure comprising:
a wire-shaped transmission member;
a housing member for housing a first portion, which is a portion of the wire-shaped transmission member; and
a protective tube for covering a second portion, which is another portion of the wire-shaped transmission member, and
an opposite-side housing member for housing a third portion that is on an opposite side to the first portion with the second portion interposed between the first portion and the third portion,
wherein the protective tube is formed to a length that reaches both the housing member and the opposite-side housing member, and
wherein the housing member includes a housing body portion for housing the first portion and an extended portion that protrudes from the housing body portion toward the second portion, and
an end portion of the protective tube overlaps the extended portion in a direction in which the wire-shaped transmission member extends, in a state in which the end portion of the protective tube is not positioned in the axis direction with respect to the extended portion.

3. The connection structure for the housing member and the protective tube according to claim 2,
wherein the end portion of the protective tube covers the extended portion.

4. The connection structure for the housing member and the protective tube according to claim 3,
wherein the extended portion is provided with a mark indicating an appropriate position of the end portion of the protective tube that covers the extended portion.

5. The connection structure for the housing member and the protective tube according to claim 4,
wherein a boundary between the housing body portion and the extended portion is the mark.

6. The connection structure for the housing member and the protective tube according to claim 2,
wherein the end portion of the protective tube is inserted into the extended portion.

7. The connection structure for the housing member and the protective tube according to claim 1,
wherein the housing member is a member that maintains a branching portion of a plurality of the wire-shaped transmission member in a fixed branching shape, and the opposite-side housing member is a connector cover that covers a connector provided at an end portion of the wire-shaped transmission members.
